(19) United States
(12) Patent Application Publication
(10) Pub. No.: US 2025/0245057 A1
(43) Pub. Date: Jul. 31, 2025

(54) MULTIMEDIA RESOURCE PROCESSING METHOD, MEDIUM AND ELECTRONIC DEVICE

(71) Applicant: Beijing Zitiao Network Technology Co., Ltd., Beijing (CN)

(72) Inventors: Honghao ZENG, Beijing (CN); Shouyao WANG, Beijing (CN)

(21) Appl. No.: 18/968,808

(22) Filed: Dec. 4, 2024

(30) Foreign Application Priority Data
Jan. 30, 2024 (CN) 202410132743.8

(51) Int. Cl. G06F 9/50

(52) U.S. Cl. CPC G06F 9/5038; G06F 2209/5021

(57) ABSTRACT

The present disclosure relates to a multimedia resource processing method, a medium and an electronic device, and the method includes: acquiring time information of a target resource to be inserted in a target track, in which the time information represents start time and end time of the target resource on a timeline of the target track; determining, according to the time information and time information of each of track resources on the target track, a conflict resource which has a time conflict with the target resource from the track resources; and adjusting the target resource and the conflict resource based on priorities and time information corresponding to the target resource and the conflict resource respectively, to determine target time information corresponding to the target resource and the conflict resource respectively.

### CROSS-REFERENCE TO RELATED APPLICATION

This application claims the priority to and benefits of the Chinese Patent Application No. 202410132743.8, which was filed on Jan. 30, 2024. The aforementioned patent application is hereby incorporated by reference in its entirety.

### TECHNICAL FIELD

The present disclosure relates to the technical field of computers, and specifically relates to a multimedia resource processing method and apparatus, a medium and an electronic device.

### BACKGROUND

With the development of computer technology, the automation level of video editing is getting higher and higher. In a multi-track resource editing system, the relevant technology allows a user to place and adjust various multimedia resources, such as video clips, audio clips, and texts, on a plurality of independent tracks.

In the relevant technology, the user can edit and adjust timeline for different types of resources to achieve resource management in the plurality of tracks. However, the above process is usually to manage and synchronize resources between different tracks, and it is difficult to adjust and manage resources within the same track.

### SUMMARY

This summary is provided to introduce concepts in a brief form, which will be described in detail in the detailed description later. This summary is not intended to identify key features or essential features of the claimed technical solution, nor is it intended to limit the scope of the claimed technical solution.

In a first aspect, the present disclosure provides a multimedia resource processing method, including:
acquiring time information of a target resource to be inserted in a target track, wherein the time information represents start time and end time of the target resource on a timeline of the target track;
determining, according to the time information and time information of each of track resources on the target track, a conflict resource which has a time conflict with the target resource from the track resources; and
adjusting the target resource and the conflict resource based on priorities and time information corresponding to the target resource and the conflict resource respectively, to determine target time information corresponding to the target resource and the conflict resource respectively.

In a second aspect, the present disclosure provides a multimedia resource processing apparatus, including:
a first acquisition module, configured to acquire time information of a target resource to be inserted in a target track, wherein the time information represents start time and end time of the target resource on a timeline of the target track;
a determination module, configured to determine, according to the time information and time information of each of track resources on the target track, a conflict resource which has a time conflict with the target resource from the track resources; and
an adjustment module, configured to adjust the target resource and the conflict resource based on priority and time information corresponding to the target resource and the conflict resource respectively, to determine the target time information corresponding to the target resource and the conflict resource respectively.

In a third aspect, the present disclosure provides a computer-readable medium on which a computer program is stored, wherein the program is executed by a processing apparatus to execute the steps of the method according to the first aspect.

In a forth aspect, the present disclosure provides an electronic device, including:
a storage apparatus on which a computer program is stored; and
a processing apparatus which is configured to execute the computer program in the storage apparatus to implement the steps of the method according to the first aspect.

The above technical solution includes: acquiring time information of a target resource to be inserted in a target track, determining a conflict resource which has a time conflict with the target resource from track resources according to the time information and the time information of each track resource on the target track, and further adjusting the target resource and the conflict resource based on the priority and the time information corresponding to the target resource and the conflict resource respectively, and determining target time information corresponding to the target resource and the conflict resource respectively. Therefore, automatic determination and adjustment of a resource conflict can be realized in a single-track editing environment, and a user does not need to carry out conflict identification and manually adjust the duration of the resource or move the resource to solve the conflict, so that the manual adjustment operation of the user in the resource processing process is reduced, the resource processing process is simplified, and the resource processing and editing efficiency is improved, and moreover, the overall quality of the finally obtained resource can be improved through resource conflict determination and adjustment, and the resource usage problem caused by resource editing errors is avoided. In addition, the timeline management in the resource processing process can be effectively simplified, and the resource processing process is more intuitive and easier to operate by the user who is not familiar with complex timeline management.

Other features and advantages of the present disclosure will be described in detail with the following specific embodiments.

### BRIEF DESCRIPTION OF DRAWINGS

The above and other features, advantages and aspects of the embodiments of the present disclosure will become more apparent with reference to the following specific embodiments in conjunction with the accompanying drawings. Throughout the accompanying drawings, the same or similar reference signs represent the same or similar elements. It is to be understood that the accompanying drawings are schematic and the originals and elements are not necessarily drawn to scale. In the accompanying drawings:

FIG. 1 is a flowchart of a multimedia resource processing method provided according to an embodiment of the present disclosure.

FIG. 2 is a schematic diagram of a track resource and a target resource in a target track provided according to an embodiment of the present disclosure.

FIG. 3 is a block diagram of a multimedia resource processing apparatus provided according to an embodiment of the present disclosure.

FIG. 4 shows a structural schematic diagram of an electronic device suitable for realizing an embodiment of the present disclosure.

### DETAILED DESCRIPTION

Embodiments of the present disclosure will be described in more detail below with reference to the accompanying drawings. Although some embodiments of the present disclosure are shown in the accompanying drawings, it should be understood that the present disclosure can be embodied in various forms and should not be construed as limited to the embodiments set forth here, but rather, these embodiments are provided for a more thorough and complete understanding of the present disclosure. It should be understood that the accompanying drawings and embodiments of the present disclosure are only used for illustrative purposes, and are not used to limit the protection scope of the present disclosure.

It should be understood that the steps described in the method implementations of the present disclosure may be performed in a different order and/or in parallel. Furthermore, method embodiments may include additional steps and/or omit performing the illustrated steps. The scope of the present disclosure is not limited in this respect.

As used herein, the term “including” and its variants are open-ended including, that is, “including but not limited to”. The term “based on” is “at least partially based on”. The term “one embodiment” means “at least one embodiment”. The term “another embodiment” means “at least one other embodiment”. The term “some embodiments” means “at least some embodiments”. Related definitions of other terms will be given in the following description.

It should be noted that the concepts of “first” and “second” mentioned in this disclosure are only used to distinguish different devices, modules or units, and are not used to limit the order or interdependence of the functions performed by these devices, modules or units.

It should be noted that the modifications of “a” and “a plurality” mentioned in this disclosure are schematic rather than limiting, and those skilled in the art should understand that unless the context clearly indicates otherwise, they should be understood as “one or more”.

The names of messages or information in interaction among a plurality of apparatuses in the embodiment of present disclosure are for illustrative purposes only and are not intended to limit the scope of such messages or information.

It is to be understood that before using the technical solutions disclosed in each embodiment of the present disclosure, it is needed to inform the type, scope of usage, and usage scenarios of the personal information involved in the present disclosure to a user and gain the authorization of the user through appropriate methods in accordance with relevant laws and regulations.

For example, prompt information is transmitted to the user in response to an active request of the user so as to clearly prompt the user, the operation requested to be executed needs to gain and use the personal information of the user. Therefore, the user can autonomously select whether to provide personal information to software or hardware such as an electronic device, an application, a server or a storage medium executing the operation of the technical solution of the present disclosure according to the prompt information.

As an optional but non-limited implementation mode, the way of transmitting the prompt information to the user in response to receiving the active request of the user can be a popup window way, and the prompt information can be presented in a character mode in the popup window. In addition, the popup window can also carry a selection control for the user to select “Agree” or “Disagree” to provide personal information to the electronic device.

It is to be understood that the above-mentioned processing of notifying and obtaining the authorization of the user is only schematic and do not limit the implementation of the present disclosure, and other ways that meet the relevant laws and regulations can also be applied to the implementation of the present disclosure.

It is to be understood that data involved in this technical solution (including but not limited to the data itself, acquisition or use of data) shall comply with the requirements of relevant laws and regulations and relevant provisions.

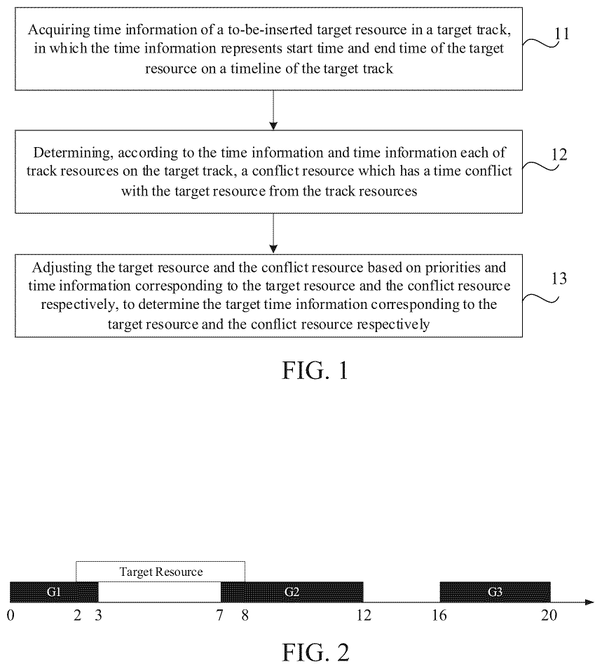

FIG. 1 is a flowchart of a multimedia resource processing method provided according to an embodiment of the present disclosure, as shown in FIG. 1, the method can include:

Step 11: acquiring time information of a target resource to be inserted in a target track, in which the time information represents start time and end time of the target resource on a timeline of the target track.

The target resource can be any type of multimedia resource, such as a video, an audio, a text, and an animation. As an example, a plurality of processing tracks can be contained in the multimedia resource editing scenario, the track into which the target resource is inserted can be used as the target track. In the present disclosure, time information of the target resource is acquired when the target resource is inserted into the target track, so that whether the target resource conflicts with existing resources in the target track or not can be automatically determined.

As an example, the time information of the target resource can be used for representing the corresponding time on the timeline in response to that the user inserts the target resource into the target track, for example, it can be recorded as [Viₛₜₐᵣₜ, Vi_{end}], in which, Viₛₜₐᵣₜ represents the start time of the i^{th} resource, and Vi_{end} represents the end time of the i^{th} resource.

Step 12: determining, according to the time information and time information of each of track resources on the target track, a conflict resource which has a time conflict with the target resource from the track resources.

The track resources can represent added resources in the target track. As an example, as shown in FIG. 2, there are track resources G1, G2 and G3 in a target track A1, in which time information of G1 is 0-3, time information of G2 is 7-12, and time information of G1 is 16-20. The conflict resource with an expected time conflict can be determined from the track resources based on the time information of the target resource. In response to that the time information of the target resource is 2-8, the conflict resources G1 and G2 can be further determined.

Step 13: adjusting the target resource and the conflict resource based on priorities and time information corresponding to the target resource and the conflict resource respectively, to determine the target time information corresponding to the target resource and the conflict resource respectively.

In step 12, each existing track resource which has the time conflict with the target resource can be automatically determined while inserting the target resource into the target track. The priority can be pre-configured and can also be dynamically adjusted according to the usage condition of the target resource and the conflict resource. In the embodiment, the priority degree between the target resource and the conflict resource can be determined based on the priority, the resource with high priority can be reserved, the resource with low priority can be deleted or cut, and therefore the target time information corresponding to the adjusted resources are determined respectively, which facilitates the comparison with subsequently inserted resources.

Therefore, the above technical solution includes: acquiring time information of the target resource to be inserted in the target track, determining the conflict resource which has the time conflict with the target resource from track resources according to the time information and the time information of each track resource on the target track, and further adjusting the target resource and the conflict resource based on the priority and the time information corresponding to the target resource and the conflict resource respectively, and determining target time information corresponding to the target resource and the conflict resource respectively. Therefore, automatic determination and adjustment of the resource conflict can be realized in the single-track editing environment, and the user does not need to carry out conflict identification and manually adjust the duration of the resource or move the resource to solve the conflict, so that the manual adjustment operation of the user in the resource processing process is reduced, the resource processing process is simplified, and the resource processing and editing efficiency is improved; and moreover, the overall quality of the finally obtained resource can be improved through resource conflict determination and adjustment, and the resource usage problem caused by resource editing errors is avoided. In addition, the timeline management in the resource processing process can be effectively simplified, and the resource processing process is more intuitive and easier to operate by the user who is not familiar with complex timeline management.

In a possible embodiment, the step of determining, according to the time information and the time information each of track resources on the target track, the conflict resource which has the time conflict with the target resource from the track resources may include:

performing intersection processing on a first set corresponding to the time information of the target resource and a second set corresponding to the time information of the track resource respectively.

The corresponding set can be determined based on the time information of each resource; for example, as described in the above example, the target track A1 contains the track resources G1, G2 and G3, the second set corresponding to the time information of G1 is represented as [0,3], the second set corresponding to the time information of G2 is represented as [7,12], the second set corresponding to the time information of G1 is represented as [16,20], and the first set corresponding to the time information of the target resource is represented as [2,8].

In this step, intersection processing can be directly carried out on the first set and the second set to determine whether the two sets have an intersection or not when determining whether the target resource and the track resource have a time conflict or not. The way of the intersection processing can be realized based on a way of finding an intersection of two sets in the field, which is not limited in the present disclosure.

In response to that the second set forms an intersection with the first set exists, it is determined that the target resource has the time conflict, and the track resource corresponding to the second set to which the intersection belongs is taken as the conflict resource.

In response to that there is the intersection between the first set and the second set, it is determined that the time conflict exists between the first and the second set, and a corresponding intersection time can be further obtained. As described in the above example, in response to that the first set and the second set corresponding to G1 have an intersection J1, the track resource G1 to which the interaction J2 belongs serves as the conflict source; in response to that the first set and the second set corresponding to G2 have an intersection J2, the track resource G2 to which the intersection J2 belongs serves as the conflict resource; and in response to that the first set and the second set corresponding to G3 do not have an intersection, and no conflict exists between the first set and the second set.

Therefore, through the above technical solution, the start time and the end time of each resource can be determined, so that whether conflicts exist between different resources or not can be quickly and accurately determined in a way of finding the intersection based on a set theory, the conflict resource determination efficiency and accuracy are improved, and accurate data support is provided for subsequent adjustment of the conflict resource.

In a possible embodiment, before adjusting the target resource and the conflict resource based on the priority and the time information corresponding to the target resource and the conflict resource respectively, and determining the target time information corresponding to the target resource and the conflict resource respectively, the method further includes:
in response to that the target track is not a main track corresponding to the target resource, acquiring basic time information corresponding to a resource(s) in the main track, wherein the basic time information containing earliest start time and latest end time corresponding to the resource(s) in the main track.

A resource processing system can include a plurality of tracks, for example, in an animation scenario of adding a picture-in-picture by taking a video resource as a background, a track corresponding to the video resource can be used as the main track, and in response to that the target track is an animation track, animation insertion generally needs to be carried out in the overall time corresponding to the video resource in the embodiment so as to ensure corresponding background display of the inserted animation during playing.

In the embodiment, the time corresponding to the resource(s) in the main track can be obtained, and in response to that only one resource exists in the main track, the time information corresponding to the only one resource can be directly used as the basic time information. In response to that the main track contains a plurality of resources, the time information of the plurality of resources can be respectively acquired, and the earliest start time and the latest end time in the time information can be treated as the basic time information to represent the overall time information corresponding to the resources in the main track.

In response to that the time information of the target resource is not completely contained in the basic time information, a resource corresponding to a time part which is not contained in the basic time information in the target resource is deleted, and updated time information of the target resource is obtained according to the target resource obtained after deletion.

As an example, in response to that the corresponding basic time information in the main track is represented as [0,20], and the time information of the target resource is represented as [18,22], the time information of the target resource in the scenario is not completely contained in the basic time information, and the target resource can be deleted and then inserted into the target track so as to ensure the time consistency of the target track and the main track.

As an example, the time part, which is not contained in the basic time information, namely, the resource corresponding to [20,22], in the target resource can be deleted, and the updated time information of the target resource can be obtained according to the target resource obtained after deletion, that is, the time information of the target resource after deletion can be represented as [18,20]. Then, in response to that conflict determination is carried out on the target resource and the track resource in the target track, determination can be carried out based on the updated time information, so that the consistency of the time information of the resources in the target track and the main track can be ensured, a resource(s) exceeding the resource time in the main track is (are) prevented from appearing in the target track, and finally the accuracy and effectiveness of the multi-track synthesized resources are ensured.

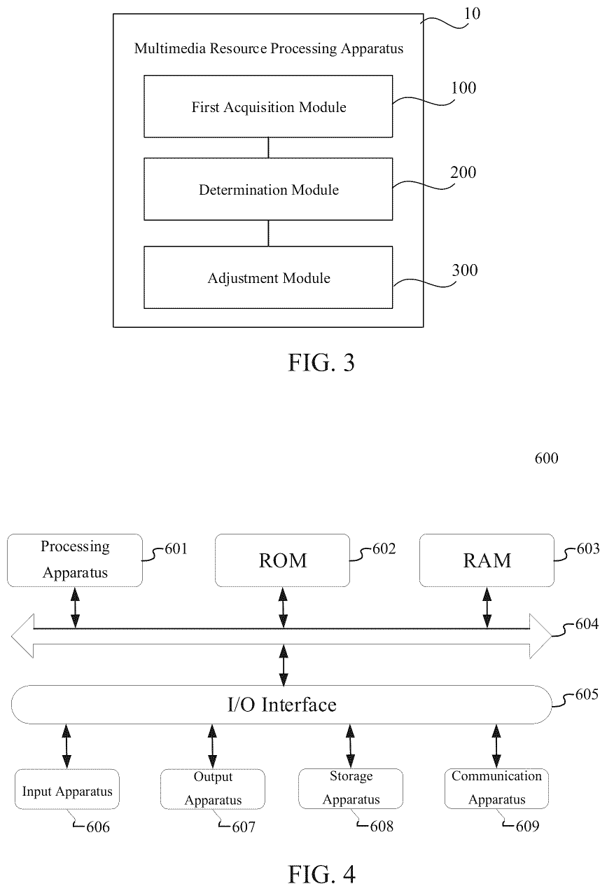

In a possible embodiment, the exemplary implementation mode of adjusting the target resource and the conflict resource based on the priority and the time information corresponding to the target resource and the conflict resource respectively, and determining the target time information corresponding to the target resource and the conflict resource respectively is shown in FIG. 3, and the step may include:

Step 31: determining a first resource and a second resource according to the priority of the target resource and the priority of the conflict resource, in which a priority of the first resource is higher than that of the target resource, and a priority of the second resource is lower than that of the target resource.

The priority of the target resource and the priority of the conflict resource can be respectively acquired, and whether each conflict resource is the first resource or the second resource is determined by comparing the priorities.

As an example, in response to that each resource is configured with a priority at a single dimension, corresponding priority can be directly acquired for comparison, for example, for an admission animation corresponding to G1, in response to that the target resource is a common animation, and the admission animation is higher than the common animation in priority, it can be determined that the priority of G1 is higher than the target resource, and the G1 can be treated as the first resource.

In response to that the priorities of the two are same, the level of the priority can be determined based on the insertion time, and a corresponding relationship between the insertion time and the level of the priority can be set based on an actual application scenario, which is not limited in the present disclosure.

As another example, the priority contains priority at a plurality of dimensions; and the step of determining the first resource and the second resource according to the priority of the target resource and the priority of the conflict resource may include:
acquiring priority values of the target resource and the conflict resource at each dimension.

As an example, the dimensions can contain a plurality of dimensions selected from a group of content priority, type priority, dynamic priority and custom priority, and the preset sequence is the custom priority, dynamic priority, type priority and content priority in sequence, that is, the importance degrees of the priority dimensions are the custom priority, dynamic priority, type priority and content priority in sequence from high to low.

The content priority represents the priority configured based on a content of a resource, and as an example, a priority value corresponding to the resource can be obtained according to the importance of the content or the user preference, for example, high priority can be set for key video clips, important text clips, admission animations and the like, and common priority can be set for other contents.

The type priority represents the priority configured based on the data type of the resource, in which the target resource can be any type of resource, the priority of the resources under different types can be preset, and a basic priority is distributed for the resource according to the type of each resource, the basic priority reflects the general importance of different types of resources in the processing process. As an example, the video can be set to be at the highest priority; and the audio, text and animation can have the same priority or be configured according to actual application scenarios. The importance degree of the type priority is higher than that of the content priority, for example, when two resources have the type priority and the content priority, when judging the priority level, the judgment is made preferentially based on the type priority.

As an example, different identifiers can be set for different types of resources, so that the types can be directly determined based on the identifiers, and then corresponding type priority can be determined, for example, video clips, audio clips, animation clips and text clips are classified based on different identifiers.

The dynamic priority represents the priority determined based on the operation information of the resource, and in the process of processing the resource, the dynamic priority of the resource can be dynamically adjusted according to the usage situation of the resource and user interaction. As an example, the operation information can be a number of times that the user adjusts the resource in the latest historical period, and the higher the number of times corresponding to the operation information is, the higher the dynamic priority corresponding to the resource is. For another example, the operation information can be the latest and longest unused information corresponding to the resource, and for the latest and longest unused resource, it is indicated that the possibility that the user uses this resource is low, and at the moment, the dynamic priority corresponding to this resource can be reduced. As an example, the dynamic priority can be represented based on a score. The importance degree of the dynamic priority is higher than the type priority and the content priority, for example, when two resources have the dynamic priority, the type priority and the content priority, when judging the priority level, the judgment is made preferentially based on the dynamic priority.

The custom priority represents the priority pre-configured by the user for the resource.

In the process of processing the resource, the user is allowed to customize the priority of each resource. If a resource is considered as the most important by the user, the priority can be customized for it, so as to avoid the influence of subsequent inserted resources on the resource. The custom priority can support the usage requirement of the user. As an example, when resources are added to the target track, a priority configuration interface can be displayed, and the user can set the priority value at the corresponding dimension in the priority configuration interface, so that the priority of each resource is obtained.

As an example, in response to that the user does not set the priority at a certain dimension, default setting can be carried out based on the priority rule corresponding to the dimension, and in response to that the user does not select a corresponding content tag in the content priority, the priority value of the resource at the dimension can be directly set to be the common priority.

Therefore, according to the above technical solution, priority values at the plurality of dimensions can be configured for the resources, priority comparison at more dimensions can be carried out during subsequent priority determination, and comprehensive data support is provided for priority determination of the conflict resource.

Then, for the target resource and any conflict resource, based on a preset sequence of dimensions, the priority value at the current dimension is acquired;
in response to the priority values at the current dimension are different, determining the conflict resource to be the first resource or the second resource based on the priority values at the current dimension; and
in response to the priority values at the current dimension are same, taking the next dimension as the current dimension according to the preset sequence, and returning to the step of acquiring the priority values at the current dimension.

As an example, for the conflict resource G1, the corresponding priority is represented as {custom priority: null; dynamic priority: 90; type priority: audio; content priority: common priority}, the priority corresponding to the target resource is represented as {custom priority: null; dynamic priority: 80; type priority: video; content priority: common priority}, and the priority corresponding to the conflict resource G2 is represented as {custom priority: null; dynamic priority: 80; type priority: audio; content priority: high priority}.

When the priority of G1 is compared with the priority of the target resource, the custom priority is preferably acquired according to the preset sequence of the dimension, the priority values of the two at the dimension are both null; at the moment, the next dimension is acquired according to the preset sequence of the dimension, namely the dynamic priority, and the priority value of G1 at the dimension is 90, the priority value of the target resource is 80, the priority values of the two under the dynamic priority are different, and the priority value of G1 is higher than the priority value of the target resource, and then the conflict resource G1 is determined to be the first resource.

When the priority of G2 is compared with the priority of the target resource, the custom priority is preferably acquired according to the preset sequence of the dimension, and the priority values of the two at the dimension are both null; at the moment, the next dimension is acquired according to the preset sequence of the dimensions, namely the dynamic priority, and the priority values of the two at the dimension are both 80; at the moment, the next dimension is acquired according to the preset sequence of the dimensions, namely the type priority, and the priority value of G2 at the dimension is audio, the priority value of the target resource is video, the priority values of the two under the type priority are different, and the priority value of G2 is lower than the priority value of the target resource, and then the conflict resource G2 is determined to be the second resource.

Therefore, according to the above technical solution, in response to that the resource corresponds to the priority at a plurality of dimensions, the priority can be sequentially compared according to the importance sequence of the priorities at different dimensions, so that the priority level status of each conflict resource and the target resource can be determined, and data reference is provided for subsequent conflict resolution.

Referring to FIG. 3 again, step 32: adjusting the target resource according to time information of the first resource and the time information of the target resource to obtain target time information corresponding to the target resource.

In this step, the priority of the first resource is higher than that of the target resource, and in response to a conflict between the first resource and the target resource, it is needed to adjust the target resource to avoid time conflict between the first resource and the target resource. As an example, the target resource can be deleted, namely, the target resource is not allowed to be inserted into the current position. As another example, the implementation of step 32 may include:
determining intersection time corresponding to the first resource and the target resource according to time information of each first resource and the time information of the target resource.

As described in the above sample, based on the time information of the first resource and the time information of the target resource, the corresponding intersection time can be determined to be [2,3]. In response to a plurality of first resources, the intersection time corresponding to each first resource and the target resource can be determined respectively.

And then, a part of the target resource which corresponding to the intersection time in the target resource is deleted, and the target time information corresponding to the target resource is obtained according to the target resource obtained after deletion.

For example, it can be represented by the following:

$${R}_{new}^{temp} = {R}_{new} \backslash {{I}^{N}}_{{i = 1}_{Pi > Pnew}} ( {R}_{i} ⋂ {R}_{new} )$$

R_{new}^{temp} represents the target resource; R_{new} represents the deleted target resource, and
N represents the number of resources in the target track; Pi>Pnew represents that the priority Pi of the i^{th} track resource is higher than the priority Pnew of the target resource; and Rᵢ∩R_{new} represents the intersection time of the time information Rᵢ of the i^{th} track resource and the time information R_{new} of the target resource.

As described in the above example, the part of the target resource which corresponding to the time information [2,3] in the target resource can be deleted, the target resource after deletion contains the data of the [3,8] part, namely, the data corresponding to the 1^{st} minute in the target resource is deleted, and the corresponding target time information in the target resource obtained after deletion can be expressed as [3,8].

As an example, prompt information can be outputted based on the deletion operation on the target resource, and the prompt information is used for prompting the user to delete the target resource, so that the user can know the actual status corresponding to the resource insertion in time, and the user can be supported to make an adjustment.

Therefore, the target resource can be deleted, so that the conflict between the target resource and the existing resource in the target track during inserting the target resource into the target track is avoided, the effective and accurate management of the resources in the target track is ensured, and moreover, data reference is provided for the user to carry out multimedia resource processing.

Step 33: adjusting the second resource according to the target time information corresponding to the target resource and time information of the second resource to obtain target time information corresponding to the second resource.

In this step, the priority of the second resource is lower than that of the target resource, and in response to a conflict between the second resource and the target resource, it is needed to adjust the second resource after the target resource is adjusted, so as to avoid the time conflict between the second resource and the target resource. As an example, the second resource can be deleted, namely, the second resource conflicting with the target resource is deleted after the target resource is inserted into the current position.

As another example, the implementation mode of step 33 may include:
determining intersection time corresponding to the second resource and the target resource according to time information of each second resource and the target time information of the target resource.

The way of determining the intersection time is the same as the way of determining the intersection time of the first resource and the target resource, which will not be listed here.

For each second resource, the second resource is adjusted according to the intersection time corresponding to the second resource and an adjustment rule, and the target time information corresponding to the second resource is obtained according to the second resource obtained after adjustment.

As an example, a default adjustment rule can be configured, for example, the adjustment rule can be to delete the part corresponding to the intersection time in the second resource, for example, it can be represented by the following:

$$∀ i ∈ \{ 1 , 2 , … , N \} ,$$

$$if Pi < Pnew and ( {R}_{i} ⋂ {R}_{new}^{temp} \neq ∅ ) ,$$

$$then {R}_{i} = {R}_{i} ∖ ( {R}_{i} ⋂ {R}_{new}^{temp} )$$

As an example, in response to that the time information of the second resource G2 is represented as [7,12], and the intersection time corresponding to the target resource is represented as [7,8], the part corresponding to the time information of [7,8] in the second resource can be deleted, the second resource after deletion contains the data of the [8,12] part, namely, the data corresponding to the 1^{st} minute in the second resource is deleted, and the target time information corresponding to the second resource after deletion can be represented as [8,12].

As another example, the adjustment rule can be outputted and displayed to the user, and in response to a selection operation of the user, the adjustment rule indicated by the selection operation is served as the used adjustment rule. In response to that the adjustment rule may contain deletion and delay, and when the user selects delay, delay processing can be carried out according to the time information of the second resource; in response to that the target time information of the target resource is [3,8], and the time period corresponding to the intersection time is 1 minute, the second resource can be delayed for 1 minute, that is, the time information of the second resource G2 is adjusted to be [8,13], and whether time conflict exists between the delayed second resource G2 and other track resources or not is determined. In response to no time conflict, the time information obtained after delay can be used as the corresponding target time information. In response to time conflict, a prompt can be outputted to the user to prompt the user that the current second resource may have a conflict after being delayed, so that the user can know the resource arrangement condition in time.

Based on the same inventive concept, the present disclosure further provides a multimedia resource processing apparatus, as shown in FIG. 3, an apparatus 10 includes:
a first acquisition module 100 which is configured to acquire time information of a target resource to be inserted in a target track, in which the time information represents start time and end time of the target resource on a timeline of the target track;
a determination module 200 which is configured to determine, according to the time information and time information of each of track resources on the target track, a conflict resource which has a time conflict with the target resource from the track resources; and
an adjustment module 300 which is configured to adjust the target resource and the conflict resource based on priorities and time information corresponding to the target resource and the conflict resource respectively, to determine the target time information corresponding to the target resource and the conflict resource respectively.

Optionally, the adjustment module includes:
a first determination submodule which is configured to determine a first resource and a second resource according to the priority of the target resource and the priority of the conflict resource, wherein a priority of the first resource is higher than that of the target resource, and a priority of the second resource is lower than that of the target resource;
a first adjustment submodule which is configured to adjust the target resource according to time information of the first resource and the time information of the target resource to obtain the target time information corresponding to the target resource; and
a second adjustment submodule which is configured to adjust the second resource according to the target time information corresponding to the target resource and time information of the second resource to obtain the target time information corresponding to the second resource.

Optionally, the priority contains priority at a plurality of dimensions; and the first determination submodule includes:
a first acquisition submodule which is configured to acquire priority values of the target resource and the conflict resource at each dimension;
a second acquisition submodule which is configured to: for the target resource and any conflict resource, acquire the priority values at the current dimension based on a preset sequence of the dimensions; and
a second determination submodule which is configured to: in response to the priority values at the current dimension are different, determine the conflict resource to be the first resource or the second resource based on the priority values at the current dimension; and in response to the priority values at the current dimension are same, take the next dimension as the current dimension according to the preset sequence, and trigger the second acquisition submodule to acquire the priority values at the current dimension.

Optionally, the dimensions contain a plurality of dimensions selected from a group of content priority, type priority, dynamic priority and custom priority, and the preset sequence is the custom priority, the dynamic priority, the type priority and the content priority in sequence;
the content priority represents the priority configured based on a content of a resource;
the type priority represents the priority configured based on the data type of the resource;
the dynamic priority represents the priority determined based on the operation information of the resource; and
the custom priority represents the priority pre-configured by the user for the resource.

Optionally, the first adjustment submodule includes:
a third determination submodule which is configured to determine intersection time corresponding to the first resource and the target resource according to the time information of each first resource and the time information of the target resource; and
a deletion submodule which is configured to delete a part of the target resource which corresponding to the intersection time, and obtain the target time information corresponding to the target resource according to the target resource obtained after deletion.

Optionally, the second adjustment submodule includes:
a fourth determination submodule which is configured to determine intersection time corresponding to the second resource and the target resource according to time information of each second resource and the target time information of the target resource; and
a third adjustment submodule which is configured to: for each second resource, adjust the second resource according to the intersection time corresponding to the second resource and an adjustment rule, and obtain the target time information corresponding to the second resource according to the second resource obtained after adjustment.

Optionally, the apparatus further includes:
a second acquisition module which is configured to: before adjusting the target resource and the conflict resource based on the priority and the time information corresponding to the target resource and the conflict resource respectively, and determining the target time information corresponding to the target resource and the conflict resource respectively by the adjustment module, in response to that the target track is not a main track corresponding to the target resource, acquire basic time information corresponding to resources in the main track, wherein the basic time information containing earliest start time and latest end time corresponding to the resources in the main track; and
a deletion module which is configured to: in response to that the time information of the target resource is not completely contained in the basic time information, delete the resource corresponding to a time part which is not contained in the basic time information in the target resource, and obtain updated time information of the target resource according to the target resource obtained after deletion.

Optionally, the determination module includes:
a processing submodule which is configured to perform intersection processing on the first set corresponding to the time information of the target resource and the second set corresponding to the time information of the track resource respectively; and
a fifth determination submodule which is configured to: in response to that the second set forms an intersection with the first set exists, determine that the target resource has the time conflict, and take the track resource corresponding to the second set to which the intersection belongs as the conflict resource.

Referring to FIG. 4, FIG. 4 illustrates a schematic structural diagram of an electronic device 600 suitable for implementing some embodiments of the present disclosure. The electronic devices in some embodiments of the present disclosure may include but are not limited to mobile terminals such as a mobile phone, a notebook computer, a digital broadcasting receiver, a personal digital assistant (PDA), a portable Android device (PAD), a portable media player (PMP), a vehicle-mounted terminal (e.g., a vehicle-mounted navigation terminal), a wearable electronic device or the like, and fixed terminals such as a digital TV, a desktop computer, or the like. The electronic device illustrated in FIG. 4 is merely an example, and should not pose any limitation to the functions and the range of use of the embodiments of the present disclosure.

As illustrated in FIG. 4, the electronic device 600 may include a processing apparatus 601 (e.g., a central processing unit, a graphics processing unit, etc.), which can perform various suitable actions and processing according to a program stored in a read-only memory (ROM) 602 or a program loaded from a storage apparatus 608 into a random-access memory (RAM) 603. The RAM 603 further stores various programs and data required for operations of the electronic device 600. The processing apparatus 601, the ROM 602, and the RAM 603 are interconnected by means of a bus 604. An input/output (I/O) interface 605 is also connected to the bus 604.

Usually, the following apparatus may be connected to the I/O interface 605: an input apparatus 606 including, for example, a touch screen, a touch pad, a keyboard, a mouse, a camera, a microphone, an accelerometer, a gyroscope, or the like; an output apparatus 607 including, for example, a liquid crystal display (LCD), a loudspeaker, a vibrator, or the like; a storage apparatus 608 including, for example, a magnetic tape, a hard disk, or the like; and a communication apparatus 609. The communication apparatus 609 may allow the electronic device 600 to be in wireless or wired communication with other devices to exchange data. While FIG. 4 illustrates the electronic device 600 having various apparatuses, it should be understood that not all of the illustrated apparatuses are necessarily implemented or included. More or fewer apparatuses may be implemented or included alternatively.

Particularly, according to some embodiments of the present disclosure, the processes described above with reference to the flowcharts may be implemented as a computer software program. For example, some embodiments of the present disclosure include a computer program product, which includes a computer program carried by a non-transitory computer-readable medium. The computer program includes program codes for performing the methods shown in the flowcharts. In such embodiments, the computer program may be downloaded online through the communication apparatus 609 and installed, or may be installed from the storage apparatus 608, or may be installed from the ROM 602. When the computer program is executed by the processing apparatus 601, the above-mentioned functions defined in the methods of some embodiments of the present disclosure are performed.

It should be noted that the above-mentioned computer-readable medium in the present disclosure may be a computer-readable signal medium or a computer-readable storage medium or any combination thereof. For example, the computer-readable storage medium may be, but not limited to, an electric, magnetic, optical, electromagnetic, infrared, or semiconductor system, apparatus or device, or any combination thereof. More specific examples of the computer-readable storage medium may include but not be limited to: an electrical connection with one or more wires, a portable computer disk, a hard disk, a random-access memory (RAM), a read-only memory (ROM), an erasable programmable read-only memory (EPROM or flash memory), an optical fiber, a compact disk read-only memory (CD-ROM), an optical storage device, a magnetic storage device, or any appropriate combination of them. In the present disclosure, the computer-readable storage medium may be any tangible medium containing or storing a program that can be used by or in combination with an instruction execution system, apparatus or device. In the present disclosure, the computer-readable signal medium may include a data signal that propagates in a baseband or as a part of a carrier and carries computer-readable program codes. The data signal propagating in such a manner may take a plurality of forms, including but not limited to an electromagnetic signal, an optical signal, or any appropriate combination thereof. The computer-readable signal medium may also be any other computer-readable medium than the computer-readable storage medium. The computer-readable signal medium may send, propagate or transmit a program used by or in combination with an instruction execution system, apparatus or device. The program code contained on the computer-readable medium may be transmitted by using any suitable medium, including but not limited to an electric wire, a fiber-optic cable, radio frequency (RF) and the like, or any appropriate combination of them.

In some implementation modes, the client and the server may communicate with any network protocol currently known or to be researched and developed in the future such as hypertext transfer protocol (HTTP), and may communicate (via a communication network) and interconnect with digital data in any form or medium. Examples of communication networks include a local area network (LAN), a wide area network (WAN), the Internet, and an end-to-end network (e.g., an ad hoc end-to-end network), as well as any network currently known or to be researched and developed in the future.

The above-mentioned computer-readable medium may be included in the above-mentioned electronic device, or may also exist alone without being assembled into the electronic device.

The above-mentioned computer-readable medium carries one or more programs, and when the one or more programs are executed by the electronic device, the electronic device is caused to: acquire time information of a target resource to be inserted in a target track, in which the time information represents start time and end time of the target resource on a timeline of the target track; determine, according to the time information and time information of each of track resources on the target track, a conflict resource which has a time conflict with the target resource from the track resources; and adjusting the target resource and the conflict resource based on priorities and time information corresponding to the target resource and the conflict resource respectively, to determine target time information corresponding to the target resource and the conflict resource respectively.

The computer program codes for performing the operations of the present disclosure may be written in one or more programming languages or a combination thereof. The above-mentioned programming languages include but are not limited to object-oriented programming languages such as Java, Smalltalk, C++, and also include conventional procedural programming languages such as the “C” programming language or similar programming languages. The program code may be executed entirely on the user's computer, partly on the user's computer, as a stand-alone software package, partly on the user's computer and partly on a remote computer, or entirely on the remote computer or server. In the scenario related to the remote computer, the remote computer may be connected to the user's computer through any type of network, including a local area network (LAN) or a wide area network (WAN), or the connection may be made to an external computer (for example, through the Internet using an Internet service provider).

The flowcharts and block diagrams in the accompanying drawings illustrate the architecture, functionality, and operation of possible implementations of systems, methods, and computer program products according to various embodiments of the present disclosure. In this regard, each block in the flowcharts or block diagrams may represent a module, a program segment, or a portion of codes, including one or more executable instructions for implementing specified logical functions. It should also be noted that, in some alternative implementations, the functions noted in the blocks may also occur out of the order noted in the accompanying drawings. For example, two blocks shown in succession may, in fact, can be executed substantially concurrently, or the two blocks may sometimes be executed in a reverse order, depending upon the functionality involved. It should also be noted that, each block of the block diagrams and/or flowcharts, and combinations of blocks in the block diagrams and/or flowcharts, may be implemented by a dedicated hardware-based system that performs the specified functions or operations, or may also be implemented by a combination of dedicated hardware and computer instructions.

The modules or units involved in the embodiments of the present disclosure may be implemented in software or hardware. Among them, the name of the module or unit does not constitute a limitation of the unit itself under certain circumstances. For example, the first acquisition module can also be described as “a module for acquiring the time information of the target resource to-be-inserted in the target track”.

The functions described herein above may be performed, at least partially, by one or more hardware logic components. For example, without limitation, available exemplary types of hardware logic components include: a field programmable gate array (FPGA), an application specific integrated circuit (ASIC), an application specific standard product (ASSP), a system on chip (SOC), a complex programmable logical device (CPLD), etc.

In the context of the present disclosure, the machine-readable medium may be a tangible medium that may include or store a program for use by or in combination with an instruction execution system, apparatus or device. The machine-readable medium may be a machine-readable signal medium or a machine-readable storage medium. The machine-readable medium includes, but is not limited to, an electrical, magnetic, optical, electromagnetic, infrared, or semi-conductive system, apparatus or device, or any suitable combination of the foregoing. More specific examples of machine-readable storage medium include electrical connection with one or more wires, portable computer disk, hard disk, random-access memory (RAM), read-only memory (ROM), erasable programmable read-only memory (EPROM or flash memory), optical fiber, portable compact disk read-only memory (CD-ROM), optical storage device, magnetic storage device, or any suitable combination of the foregoing.

According to one or more embodiments of the present disclosure, an Example 1 provides a multimedia resource processing method, and the method includes:
acquiring time information of a target resource to be inserted in a target track, wherein the time information represents start time and end time of the target resource on a timeline of the target track;
determining, according to the time information and time information of each of track resources on the target track, a conflict resource which has a time conflict with the target resource from the track resources; and
adjusting the target resource and the conflict resource based on priorities and time information corresponding to the target resource and the conflict resource respectively, to determine target time information corresponding to the target resource and the conflict resource respectively.

According to one or more embodiments of the present disclosure, an Example 2 provides the method in Example 1, wherein adjusting the target resource and the conflict resource based on the priority and the time information corresponding to the target resource and the conflict resource respectively, and determining target time information corresponding to the target resource and the conflict resource respectively, includes:
determining a first resource and a second resource according to the priority of the target resource and the priority of the conflict resource, wherein a priority of the first resource is higher than that of the target resource, and a priority of the second resource is lower than that of the target resource;
adjusting the target resource according to time information of the first resource and the time information of the target resource to obtain the target time information corresponding to the target resource; and
adjusting the second resource according to the target time information corresponding to the target resource and time information of the second resource to obtain target time information corresponding to the second resource.

According to one or more embodiments of the present disclosure, an Example 3 provides the method in Example 2, wherein the priority contains priority at a plurality of dimensions; and determining the first resource and the second resource according to a priority of the target resource and the priority of the conflict resource, includes:
acquiring priority values of the target resource and the conflict resource at each dimension;
acquiring, for the target resource and any conflict resource, the priority values at the current dimension based on a preset sequence of the dimensions;
in response to the priority values at the current dimension are different, determining the conflict resource to be the first resource or the second resource based on the priority values at the current dimension; and
in response to the priority values at the current dimension are same, taking the next dimension as the current dimension according to the preset sequence, and returning to the step of acquiring the priority values at the current dimension.

According to one or more embodiments of the present disclosure, an Example 4 provides the method in Example 3, wherein the dimensions contain a plurality of dimensions selected from a group of content priority, type priority, dynamic priority and custom priority, and the preset sequence is the custom priority, the dynamic priority, the type priority and the content priority in sequence, wherein
the content priority represents the priority configured based on a content of a resource;
the type priority represents the priority configured based on the data type of the resource;
the dynamic priority represents the priority determined based on the operation information of the resource; and
the custom priority represents the priority pre-configured by a user for the resource.

According to one or more embodiments of the present disclosure, an Example 5 provides the method in Example 2, wherein adjusting the target resource according to the time information of the first resource and the time information of the target resource to obtain the target time information corresponding to the target resource, includes:
determining intersection time corresponding to the first resource and the target resource according to time information of each first resource and the time information of the target resource; and
deleting a part of the target resource which corresponding to the intersection time, and obtaining the target time information corresponding to the target resource according to the target resource obtained after deletion.

According to one or more embodiments of the present disclosure, an Example 6 provides the method in Example 2, wherein adjusting the second resource according to the target time information corresponding to the target resource and the time information of the second resource to obtain the target time information corresponding to the second resource, includes:
determining intersection time corresponding to the second resource and the target resource according to time information of each second resource and the target time information of the target resource; and
for each second resource, adjusting the second resource according to the intersection time corresponding to the second resource and an adjustment rule, and obtaining the target time information corresponding to the second resource according to the second resource obtained after adjustment.

According to one or more embodiments of the present disclosure, an Example 7 provides the method in Example 1, wherein before adjusting the target resource and the conflict resource based on the priority and the time information corresponding to the target resource and the conflict resource respectively, and determining target time information corresponding to the target resource and the conflict resource respectively, the method further includes:
in response to that the target track is not a main track corresponding to the target resource, acquiring basic time information corresponding to resources in the main track, wherein the basic time information containing earliest start time and latest end time corresponding to the resources in the main track; and
in response to that the time information of the target resource is not completely contained in the basic time information, deleting the resource corresponding to a time part which is not contained in the basic time information in the target resource, and obtaining updated time information of the target resource according to the target resource obtained after deletion.

According to one or more embodiments of the present disclosure, an Example 8 provides the method in Example 1, wherein determining the conflict resource which has the time conflict with the target resource from the track resources according to the time information and the time information of each track resource on the target track, includes:
performing intersection processing on a first set corresponding to the time information of the target resource and a second set corresponding to the time information of the track resources respectively; and
in response to that the second set forms an intersection with the first set exists, determining that the target resource has the time conflict, and taking the track resources corresponding to the second set to which the intersection belongs as the conflict resource.

According to one or more embodiments of the present disclosure, an Example 9 provides a multimedia resource processing apparatus, and the apparatus includes:
a first acquisition module which is configured to acquire time information of a target resource to be inserted in a target track, wherein the time information represents start time and end time of the target resource on a timeline of the target track;
a determination module which is configured to determine, according to the time information and time information of each of track resources on the target track, a conflict resource which has a time conflict with the target resource from the track resources; and
an adjustment module which is configured to adjust the target resource and the conflict resource based on priorities and time information corresponding to the target resource and the conflict resource respectively, to determine the target time information corresponding to the target resource and the conflict resource respectively.

According to one or more embodiments of the present disclosure, an Example 10 provides a computer-readable medium on which a computer program is stored, and the program is executed by a processing apparatus to execute the steps of the method according to any one of examples 1 to 8.

According to one or more embodiments of the present disclosure, an Example 11 provides an electronic device, including:
a storage apparatus on which a computer program is stored; and
a processing apparatus which is configured to execute the computer program in the storage apparatus to implement the steps of the method according to any one of claims 1 to 8.

The above description is only a preferred embodiment of the present disclosure and an explanation of the technical principles used. Those skilled in the art should understand that the scope of disclosure involved in the present disclosure is not limited to the technical solutions formed by the specific combination of the above technical features, but should also cover other technical solutions formed by any combination of the above technical features or their equivalent features without departing from the above disclosure concept. For example, the above features are replaced with (but not limited to) technical features with similar functions disclosed in the present disclosure.

In addition, although the operations are depicted in a specific order, this should not be understood as requiring these operations to be performed in the specific order shown or in a sequential order. In certain environments, multitasking and parallel processing may be advantageous. Similarly, although several specific implementation details are included in the above discussion, these should not be interpreted as limiting the scope of the present disclosure. Certain features described in the context of separate embodiments can also be implemented in a single embodiment in combination. Conversely, the various features described in the context of a single embodiment can also be implemented in multiple embodiments individually or in any suitable sub-combination.

Although the subject matter has been described in language specific to structural features and/or method logic actions, it is to be understood that the subject matter defined in the appended claims is not necessarily limited to the specific features or actions described above. On the contrary, the specific features and actions described above are merely example forms of implementing the claims. Regarding the apparatus in the above embodiment, the specific manner in which each module performs the operation has been described in detail in the embodiment related to the method, and will not be elaborated here.

1. A multimedia resource processing method, comprising:
acquiring time information of a target resource to be inserted in a target track, wherein the time information represents start time and end time of the target resource on a timeline of the target track;
determining, according to the time information and time information of each of track resources on the target track, a conflict resource which has a time conflict with the target resource from the track resources; and
adjusting the target resource and the conflict resource based on priorities and time information corresponding to the target resource and the conflict resource respectively, to determine target time information corresponding to the target resource and the conflict resource respectively.

2. The method according to claim 1, wherein adjusting the target resource and the conflict resource based on the priority and the time information corresponding to the target resource and the conflict resource respectively, and determining target time information corresponding to the target resource and the conflict resource respectively, comprises:
determining a first resource and a second resource according to a priority of the target resource and the priority of the conflict resource, wherein a priority of the first resource is higher than that of the target resource, and a priority of the second resource is lower than that of the target resource;
adjusting the target resource according to time information of the first resource and the time information of the target resource to obtain the target time information corresponding to the target resource; and
adjusting the second resource according to the target time information corresponding to the target resource and time information of the second resource to obtain target time information corresponding to the second resource.

3. The method according to claim 2, wherein the priority contains priority at a plurality of dimensions; and determining the first resource and the second resource according to the priority of the target resource and the priority of the conflict resource, comprises:
acquiring priority values of the target resource and the conflict resource at each dimension;
acquiring, for the target resource and any conflict resource, the priority values at the current dimension based on a preset sequence of the dimensions;
in response to the priority values at the current dimension are different, determining the conflict resource to be the first resource or the second resource based on the priority values at the current dimension; and
in response to the priority values at the current dimension are same, taking the next dimension as the current dimension according to the preset sequence, and returning to the step of acquiring the priority values at the current dimension.

4. The method according to claim 3, wherein the dimensions contain a plurality of dimensions selected from a group of content priority, type priority, dynamic priority and custom priority, and the preset sequence is the custom priority, the dynamic priority, the type priority and the content priority in sequence, wherein
the content priority represents a priority configured based on a content of a resource;
the type priority represents a priority configured based on the data type of the resource;
the dynamic priority represents a priority determined based on the operation information of the resource; and
the custom priority represents a priority pre-configured by a user for the resource.

5. The method according to claim 2, wherein adjusting the target resource according to the time information of the first resource and the time information of the target resource to obtain the target time information corresponding to the target resource, comprises:
determining intersection time corresponding to the first resource and the target resource according to time information of each first resource and the time information of the target resource; and
deleting a part of the target resource which corresponding to the intersection time, and obtaining the target time information corresponding to the target resource according to the target resource obtained after deletion.

6. The method according to claim 2, wherein adjusting the second resource according to the target time information corresponding to the target resource and the time information of the second resource to obtain the target time information corresponding to the second resource, comprises:
determining intersection time corresponding to the second resource and the target resource according to time information of each second resource and the target time information of the target resource; and
for each second resource, adjusting the second resource according to the intersection time corresponding to the second resource and an adjustment rule, and obtaining the target time information corresponding to the second resource according to the second resource obtained after adjustment.

7. The method according to claim 1, wherein before adjusting the target resource and the conflict resource based on the priority and the time information corresponding to the target resource and the conflict resource respectively, and determining target time information corresponding to the target resource and the conflict resource respectively, the method further comprises:
in response to that the target track is not a main track corresponding to the target resource, acquiring basic time information corresponding to resources in the main track, wherein the basic time information containing earliest start time and latest end time corresponding to the resources in the main track; and
in response to that the time information of the target resource is not completely contained in the basic time information, deleting a part of the target resource corresponding to a time part which is not contained in the basic time information in the target resource, and obtaining updated time information of the target resource according to the target resource obtained after deletion.

8. The method according to claim 1, wherein determining, according to the time information and the time information each of track resources on the target track, the conflict resource which has the time conflict with the target resource from the track resources, comprises:
performing intersection processing on a first set corresponding to the time information of the target resource and a second set corresponding to the time information of the track resources respectively; and
in response to that the second set forms an intersection with the first set exists, determining that the target resource has the time conflict, and taking the track resources corresponding to the second set to which the intersection belongs as the conflict resource.

9. An electronic device, comprising:
at least a processor, and
a non-transitory memory with instructions thereon,
wherein the instructions upon execution by the processor, cause the processor to:
acquire time information of a target resource to be inserted in a target track, wherein the time information represents start time and end time of the target resource on a timeline of the target track;
determine, according to the time information and time information of each of track resources on the target track, a conflict resource which has a time conflict with the target resource from the track resources; and
adjust the target resource and the conflict resource based on priorities and time information corresponding to the target resource and the conflict resource respectively, to determine target time information corresponding to the target resource and the conflict resource respectively.

10. The electronic device according to claim 9, wherein the processor is further caused to:
determine a first resource and a second resource according to the priority of the target resource and the priority of the conflict resource, wherein a priority of the first resource is higher than that of the target resource, and a priority of the second resource is lower than that of the target resource;
adjust the target resource according to time information of the first resource and the time information of the target resource to obtain the target time information corresponding to the target resource; and
adjust the second resource according to the target time information corresponding to the target resource and time information of the second resource to obtain target time information corresponding to the second resource.

11. The electronic device according to claim 10, wherein the priority contains priority at a plurality of dimensions; and the processor is further caused to:
acquire priority values of the target resource and the conflict resource at each dimension;
acquire, for the target resource and any conflict resource, the priority values at the current dimension based on a preset sequence of the dimensions;
in response to the priority values at the current dimension are different, determine the conflict resource to be the first resource or the second resource based on the priority values at the current dimension; and
in response to the priority values at the current dimension are same, take the next dimension as the current dimension according to the preset sequence, and return to the step of acquiring the priority values at the current dimension.

12. The electronic device according to claim 11, wherein the dimensions contain a plurality of dimensions selected from a group of content priority, type priority, dynamic priority and custom priority, and the preset sequence is the custom priority, the dynamic priority, the type priority and the content priority in sequence, wherein
the content priority represents a priority configured based on a content of a resource;
the type priority represents a priority configured based on the data type of the resource;
the dynamic priority represents a priority determined based on the operation information of the resource; and
the custom priority represents a priority pre-configured by a user for the resource.

13. The electronic device according to claim 10, wherein the processor is further caused to:
determine intersection time corresponding to the first resource and the target resource according to time information of each first resource and the time information of the target resource; and
delete a part of the target resource which corresponding to the intersection time, and obtain the target time information corresponding to the target resource according to the target resource obtained after deletion.

14. The electronic device according to claim 10, wherein the processor is further caused to:
determine intersection time corresponding to the second resource and the target resource according to time information of each second resource and the target time information of the target resource; and
for each second resource, adjust the second resource according to the intersection time corresponding to the second resource and an adjustment rule, and obtain the target time information corresponding to the second resource according to the second resource obtained after adjustment.

15. The electronic device according to claim 9, wherein the processor is further caused to:
in response to that the target track is not a main track corresponding to the target resource, acquire basic time information corresponding to resources in the main track, wherein the basic time information containing earliest start time and latest end time corresponding to the resources in the main track; and
in response to that the time information of the target resource is not completely contained in the basic time information, delete a part of the target resource corresponding to a time part which is not contained in the basic time information in the target resource, and obtain updated time information of the target resource according to the target resource obtained after deletion.

16. The electronic device according to claim 9, wherein the processor is further caused to:
perform intersection processing on a first set corresponding to the time information of the target resource and a second set corresponding to the time information of the track resources respectively; and
in response to that the second set forms an intersection with the first set exists, determine that the target resource has the time conflict, and take the track resources corresponding to the second set to which the intersection belongs as the conflict resource.

17. A non-transitory computer-readable storage medium storing instructions that cause at least a processor to:
acquire time information of a target resource to be inserted in a target track, wherein the time information represents start time and end time of the target resource on a timeline of the target track;
determine, according to the time information and time information of each of track resources on the target track, a conflict resource which has a time conflict with the target resource from the track resources; and
adjust the target resource and the conflict resource based on priorities and time information corresponding to the target resource and the conflict resource respectively, and determine target time information corresponding to the target resource and the conflict resource respectively.

18. The non-transitory computer-readable storage medium according to claim 17, wherein the processor is further caused to:
determine a first resource and a second resource according to the priority of the target resource and the priority of the conflict resource, wherein a priority of the first resource is higher than that of the target resource, and a priority of the second resource is lower than that of the target resource;
adjust the target resource according to time information of the first resource and the time information of the target resource to obtain the target time information corresponding to the target resource; and
adjust the second resource according to the target time information corresponding to the target resource and time information of the second resource to obtain target time information corresponding to the second resource.

19. The non-transitory computer-readable storage medium according to claim 17, wherein the processor is further caused to:
in response to that the target track is not a main track corresponding to the target resource, acquire basic time information corresponding to resources in the main track, wherein the basic time information containing earliest start time and latest end time corresponding to the resources in the main track; and
in response to that the time information of the target resource is not completely contained in the basic time information, delete a part of the target resource corresponding to a time part which is not contained in the basic time information in the target resource, and obtain updated time information of the target resource according to the target resource obtained after deletion.

20. The non-transitory computer-readable storage medium according to claim 17, wherein the processor is further caused to:
perform intersection processing on a first set corresponding to the time information of the target resource and a second set corresponding to the time information of the track resources respectively; and
in response to that the second set forms an intersection with the first set exists, determine that the target resource has the time conflict, and take the track resources corresponding to the second set to which the intersection belongs as the conflict resource.
